(19) United States
(12) Patent Application Publication
(10) Pub. No.: US 2006/0269713 A1
(43) Pub. Date: Nov. 30, 2006

(54) Flashing material with an adhesive layer including a plurality of adhesives

(76) Inventors: Kevin C. Zuege, Madison, OH (US); Louis Anthony Ferri, Solon, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/140,729

(22) Filed: May 31, 2005

(51) Int. Cl. B32B 33/00

(52) U.S. Cl. 428/40.1; 428/202

(57) ABSTRACT

The present invention is directed to a flashing material and methods of making the flashing material. The flashing material generally includes a substrate layer having a first surface and a second surface, wherein the first surface of the substrate is substantially impervious to moisture. An adhesive layer including a plurality of adhesives is deposited over the second surface of the substrate layer. The plurality of adhesives used to form the adhesive can be selected to optimize adhesion to multiple substrates and multiple exposure conditions, which provides for the flashing material to be used in a wide range of materials, surfaces, applications and/or environments. The adhesives that form the adhesive layer may be coextruded or applied sequentially.

The present invention relates generally to flashing materials and, more particularly, to flashing materials having a plurality of adhesives that are capable of forming a moisture impervious, water diverting barrier when applied to a variety of materials (e.g., building materials) and/or used in wide range of applications and environments.

### BACKGROUND OF THE INVENTION

The penetration of moisture through the exterior of a house and/or building can be a costly problem. If left unchecked, moisture penetration may severely damage the exterior structure, as well as the interior structure, and design of the house and/or building. There are several locations on the exterior of a house and/or building that are vulnerable to moisture penetration. In general, the locations that are most vulnerable to moisture penetration include those places where different building materials (e.g., wood, metal, plastic, vinyl, aluminum, etc.) are joined together, such as, for example, the joints between the building exterior walls, windows and/or doors.

Exterior siding, which generally protects various building materials, must be installed such that a gap is left between the siding and any projection from the face of the building. This gap allows for expansion and contraction of the exterior siding. Therefore, it is common for additional waterproof sealing materials (e.g., caulk) to be used to keep moisture away from the interior walls. Available sealing materials, however, have a limited effective life and eventually lose their sealant capability and must be replaced.

Flashing materials are generally used on both new construction and on renovation projects to cover gaps, joints and/or seams in the building surface. After walls are erected during new construction, these walls are typically wrapped with a water barrier. At this time, it is possible to install the flashing around the window rough opening (although the window flashing could be installed any time prior to the installation of the window.) It could be several months before a window is installed and perhaps even longer before siding is installed. If the flashing is installed early during the construction process, it is necessary for the flashing material to be of a substantial quality to protect itself from environmental pressure.

Flashing materials are generally used to deflect water that penetrates exterior siding away from the building material and/or joint. Flashing materials are used deflect water towards the exterior of a wall, window, or roof. Without proper flashing, windows, doors, and roofs will not perform to a builder or homeowner's expectation as moisture can penetrate the building material leading to its degradation. Furthermore, typical flashing materials are not optimized for use in a wide range of applications and/or environments and also can lack bonding strength to the building material.

Thus, there is a need for a flashing material that is capable of forming moisture impervious, water diverting barrier between a variety of building materials and is adaptable to a wide range of materials, surfaces, applications and/or environments and has acceptable bonding strength.

### SUMMARY OF THE INVENTION

One aspect of the present invention relates to a flashing material including: a substrate layer having a first surface and a second surface, wherein the first surface is substantially impervious to moisture; and an adhesive layer including a plurality of adhesives deposited over the second surface of the substrate layer.

Another aspect of the present invention relates to a method of making a flashing material, the method including: providing a substrate layer having a first surface and a second surface, wherein the first surface is substantially impervious to moisture; and depositing an adhesive layer including a plurality of adhesives over the second surface of the substrate layer.

Another aspect of the present invention relates to a method of making a flashing material, the method comprising: providing a web of substrate material, wherein the substrate material has a first surface that is substantially impervious to moisture and a second surface; and coextruding a plurality of adhesives to form an adhesive layer over the second surface of the substrate layer.

The foregoing and other features of the invention are hereinafter more fully described and particularly pointed out in the claims, the following description and the annexed drawings setting forth in detail illustrative embodiments of the invention, such being indicative, however, of but a few of the various ways in which the principles of the invention may be employed.

### BRIEF DESCRIPTION OF THE DRAWINGS

FIGS. 1-4a are exemplary cross-sectional views of the flashing material in accordance with aspects of the present invention.

FIGS. 5-10 are exemplary bottom views of adhesive layer in accordance with aspects of the present invention.

FIG. 11 is flow chart illustrating an exemplary method in accordance with the present invention.

FIG. 12 is an exemplary system for manufacturing the flashing material in accordance with aspects of the present invention.

FIG. 13 is a flow chart illustrating an exemplary method in accordance with the present invention.

FIG. 14 is an exemplary system for manufacturing the flashing material in accordance with aspects of the present invention.

### DETAILED DESCRIPTION

The present invention is directed to a flashing material. The flashing material includes a substrate layer having a first surface and a second surface, wherein the first surface of the substrate is substantially impervious to moisture. An adhesive layer including a plurality of adhesives is deposited over the second surface of the substrate layer. The plurality of adhesives used to form the adhesive can be selected to optimize adhesion to multiple substrates and multiple exposure conditions, which provides for the flashing material to be used with a wide range of materials, surfaces, applications and/or environments. Each adhesive of the plurality of adhesives may be optimized for a specific building material including, for example, plywood, vinyl, masonry, oriented strand board, etc. Each adhesive of the plurality of adhesives may be optimized for specific adhesive physical properties including, for example, shear strength, tack, peel strength, repositionability, tensile strength, etc. Optimization of the adhesives may be based upon a variety of physical parameters of the adhesives with the building materials including, for example, shear strength, tack, peel strength, cleavage, tensile, etc.

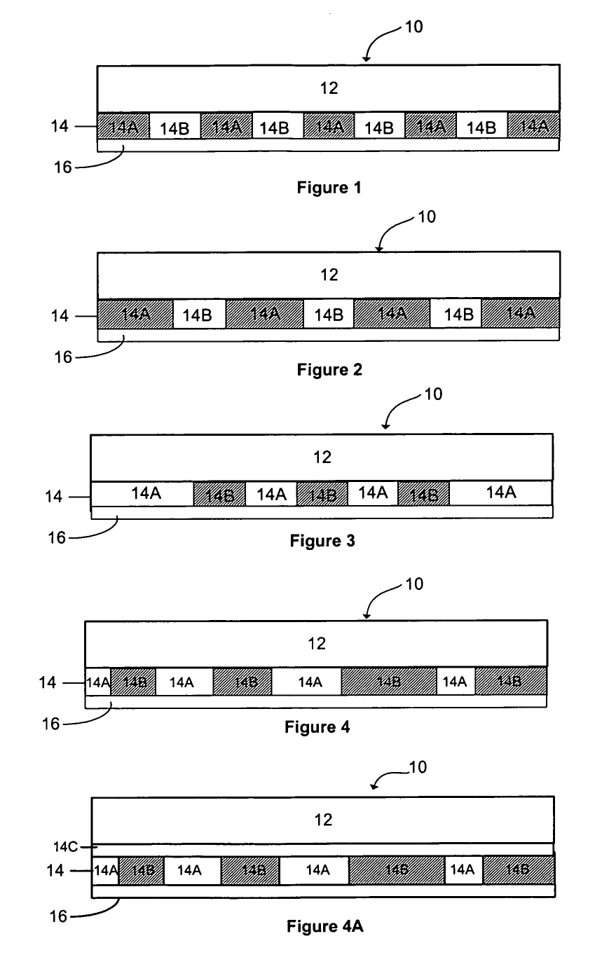

Referring to FIGS. 1-4, a flashing material 10 in accordance with the present invention is illustrated. The flashing material 10 includes a substrate layer 12, an adhesive layer 14 deposited over the substrate layer 12, and optionally, may also include a release liner 16 releasably secured to the adhesive layer 14.

The phrases “deposited over” and “formed over” as used herein, should be interpreted broadly to cover direct depositing of one layer onto another layer and also provides for one or more intermediary layers to lie between the layer deposited over another layer. For example, a first layer deposited over a second layer should be given its broadest interpretation and mean that the first layer can be deposited directly to the second layer and also allows for intermediate layers to be formed between the first and second layers.

The substrate layer 12 is generally flexible and can be any material that is substantially impervious to moisture. For example, the material may be woven or non-woven cloth made from natural or synthetic fibers and can be coated with a material to improve its ability to be impervious to water such as a polyvinyl chloride polymer or an elastomer like EPDM rubber. The woven or non-woven cloth can also be uncoated and substantially impervious to water like Gore-Tex® or non-woven polyethylene. The material can also be polymeric film including, for example, polyolefins, polyamides and other polymers. The polymeric films may also be metallized or non-metallized. Also, foils may be used. Preferably, the substrate layer 12A is also vapor impermeable and is generally stable in the presence of ultra-violet light (UV). Furthermore, the material may be creped, wrinkled or stretchable before adhesive is applied so that the material is elongatable.

Generally, the substrate layer 12 is provided in a thickness that is sufficient to prevent moisture from penetrating the substrate material. Typically, the determination of sufficient substrate thickness is dependent, at least in part, on the application, the environment, and materials in which the substrate is to be used. Preferably, the thickness of the substrate layer and is 0.03 to 5 mm and more preferably between 0.1 to 5 mm.

The adhesive layer 14 is generally formed from a plurality of adhesives that can be secured to building materials (e.g., wood, composite wood panels, OSB, masonry, aluminum, vinyl, steel, drywall, and vapor barrier). The adhesive layer 14 can be formed from any type or combination of adhesives. For example, the adhesive layer 14 may be an adhesive formulation based on two or more adhesives such as butyl rubber, natural rubber, acrylic, nitrile, etc.

Generally, the combination of adhesives is selected based upon desired physical characteristics of the adhesives in relation to the substrate and/or building material. For example, by forming an adhesive from an adhesive having a high shear strength (e.g. natural rubber, neoprene, acrylic, nitrile) with a highly tacky adhesive (e.g., butyl based adhesives, thermoplastic elastomer, ethylene/propylene rubber adhesives, styrene butadiene, PIB or asphalt), a customizable adhesive layer 14 can be achieved for a variety of applications and/or environments. This allows one skilled in the art to use two adhesives to achieve the ultimate goal of bonding together dissimilar substrates such as masonry and wood.

As shown in FIGS. 1-4, the adhesive layer includes a plurality of adhesives 14A, 14B. Preferably the adhesives are selected to optimize adhesion based on one or more issues such as: a particular substrate, under certain exposure conditions, in certain environments and to certain building materials. For example, in one formulation, the adhesive 14A can be butyl rubber based and the adhesive 14B can be acrylic based and vice versa.

An advantage for including a plurality of adhesives in the adhesive layer is to provide multiple adhesives in a flashing material that is amenable to bonding on a variety of surfaces (e.g., an adhesive formed for porous and an adhesive for non-porous substrates combined together on a single flashing material). Such a construction provides for one flashing material that can be used for many different substrates, applications and/or environments.

The adhesive layer 14 may deposited over or formed over the substrate layer 12 in any desired topography (e.g., configuration, alignment and/or pattern). The topography of the adhesives may be selected to optimize adhesion based on one or more issues such as; a particular substrate of flashing material, under certain exposure conditions, in particular environments, and to certain building materials. For example, as shown in FIGS. 1-4, the adhesives can be generally uniform in size and pitch (see FIG. 1), one adhesive can be applied in a larger area (e.g. 14A) than the other adhesive (14B) (see FIG. 2); the adhesives can have different pitches (see FIG. 3); and the adhesives can have a different size and pitch (see FIG. 4). Furthermore, it should be understood that the figures are oriented on an X-Y-Z coordinate system where the X-axis is in the machine direction. The Y-axis is across the substrate layer 12 with the Z-axis perpendicular to the substrate 12. Thus, the X-Y plane of the substrate layer forms an adhesive receiving surface with the laid down adhesive comprising an adhesive coating surface to ultimately be engaged with the building material(s). FIGS. 1-4a are viewed in the Y-Z plane.

As used in here, the term “plurality of adhesives” includes distinct types of adhesives and also includes adhesives that have the same formulation with one version of the adhesive mechanically or physically altered from the other, such as through foaming or partial curing, which provides a flashing material with tailor made properties. For example, the adhesive layer 14 may include one adhesive having a higher bonding strength, which would fail adhesively when tested on most building materials and a second adhesive having a lower strength that would fail cohesively to most building materials. The overall effect of providing such a combination of adhesives in the adhesive layer 14 is to provide a flashing material 10 having high strength adhesive that generally fails cohesively.

By way of example, a flashing material 10 may have two different adhesive formulations for the adhesive layer 14 wherein the first formulation comprises 100 g of Butyl 065®, 250 g of CaCO₃ (325 mesh), 200 g of talc (200 mesh), 10 g of aluminum stearate, 40 g of Oppanol® B-10, 120 g of Polybutene H100® and 40 g of naphthenic oil. This formulation provides good bond strength to plywood at 35° F., but by itself is likely to fail cohesively. At elevated temperatures, such as 120° F., the first formulation would have lower strength and fail cohesively. Thus, to provide good strength at higher temperatures, the adhesive layer 14 may included a second adhesive formulation comprising 100 g of Butyl 065®, CaCO₃ (325 mesh), 200 g of talc (200 mesh), 10 gof aluminum stearate, 40 g of Oppanol® B-10, 150 g of Polybutene H1900® and 40 g of naphthenic oil. This second adhesive formulation does not provide good bond strength to plywood at 35° F. and would fail adhesively at that temperature, but at 120° F., the second formulation has good bond strength to plywood. Thus, by incorporating two different adhesive formulations into the adhesive layer 14, good bond strength is provided for a range of temperatures.

As further illustrated in FIG. 4A, a tie layer may be disposed between the first surface of the substrate 12 and the adhesive layer 14. The tie layer is typically an adhesive that improves the bond between the adhesive layer 14 and the substrate layer 12. One of skill will also readily appreciate that a tie layer 14C may be used when the substrate layer 12 is stretchable and/or a metal foil to improve the bond between the adhesive layer 14 and the substrate 12.

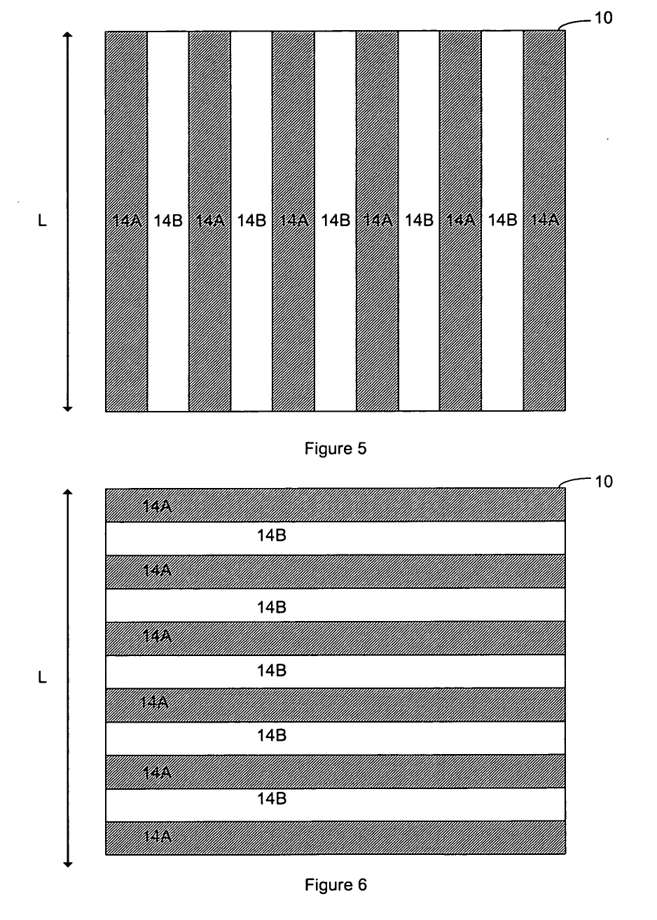

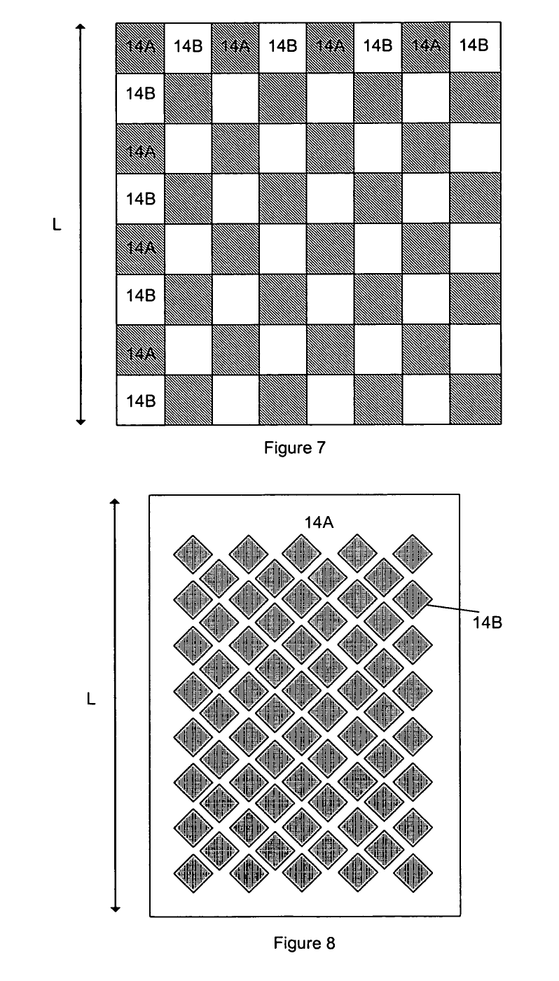

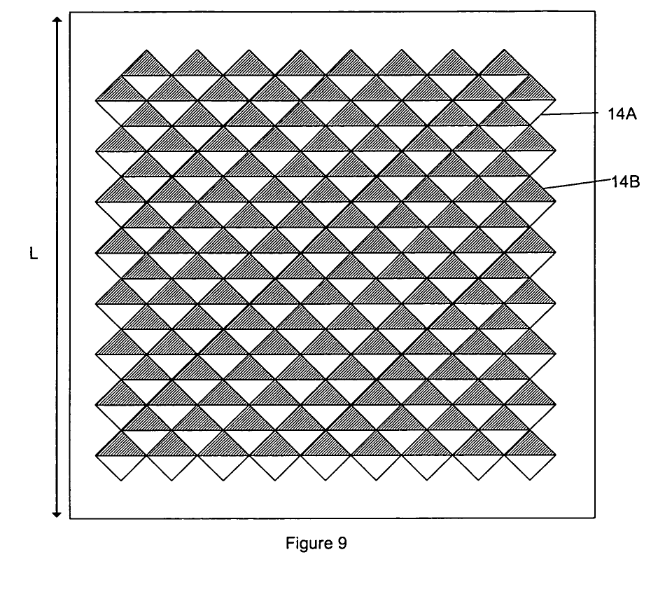

The adhesives used to form the adhesive layer 14 may be provided and/or applied in a pattern form (e.g., diamonds, triangles, stripes, squares, rectangles, checkerboard, etc.) or in a random (or quasi-random) form. As shown in FIGS. 5 and 6, the pattern may take the form of stripes. FIG. 5 illustrates a plurality of adhesives 14A, 14B applied longitudinally along the substrate web in the L direction. FIG. 6 illustrates a plurality of adhesives 14A, 14B applied perpendicular to the substrate web. Referring to FIGS. 7, 8 and 9, the pattern may also consist of a conventional checkerboard pattern (FIG. 7), a diamond pattern (FIG. 8), a triangular pattern (FIG. 9), wherein a plurality of adhesives 14A and 14B are applied to produce the desired pattern. The precise pattern or configuration of the adhesive layer may depend on one or more of the following elements: substrate of the flashing material 10, exposure conditions, environment, and/or building materials.

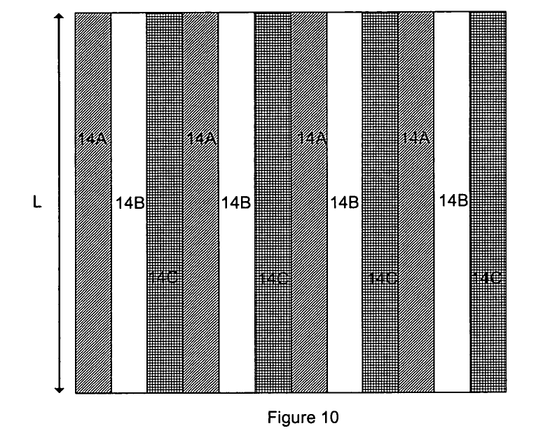

As previously stated, the plurality of adhesives that makes up the adhesive layer 14 may include two or more types of adhesives. In one embodiment, as shown in FIG. 10, the adhesive layer 14 may include three different types (or forms) of adhesives (14A, 14B, 14C). As shown in FIG. 10, the pattern may include stripes that are equally sized and have a constant pitch. Alternatively, each stripe may have a different size or a combination of equally sized stripes and uniquely sized stripes. Likewise, the pitch of the pattern may be uniform or non-uniform. As previously stated, the configuration, alignment and/or combination of adhesives is selected to optimize adhesion to the particular substrate of the flashing material, exposure conditions, environment and/or building materials in which the layer of adhesives is to secure the flashing material.

Generally, the flashing material 10 is installed along the rough opening of a window and/or doorframe. The flashing material 10 is typically cut a predetermined distance larger than the width of the rough opening. If the flashing material 10 contains a release liner 16, at least a portion of the release liner 16 is removed. The exposed portion of the adhesive layer 14 is then typically placed around the face of the rough opening (along the exterior wall). The user applying the flashing material 10 then positions the flashing material 10 exerts pressure against the substrate layer 12 to secure the adhesive layer to the building material. The remainder of the release liner 16 is then removed and the remaining portion of the flashing material 10 may be affixed to the exterior wall along the rough opening. One of ordinary skill in the art will readily appreciate that there are a variety of ways to properly secure a flashing material to the rough opening and that the particular method used may depend upon the precise application.

The flashing material 10 may be formed in any manner. For example, the adhesives forming the adhesive layer 14 may be coextruded and formed over the substrate layer 12. The adhesives forming the adhesive layer may also be sequentially applied to form the adhesive layer 14.

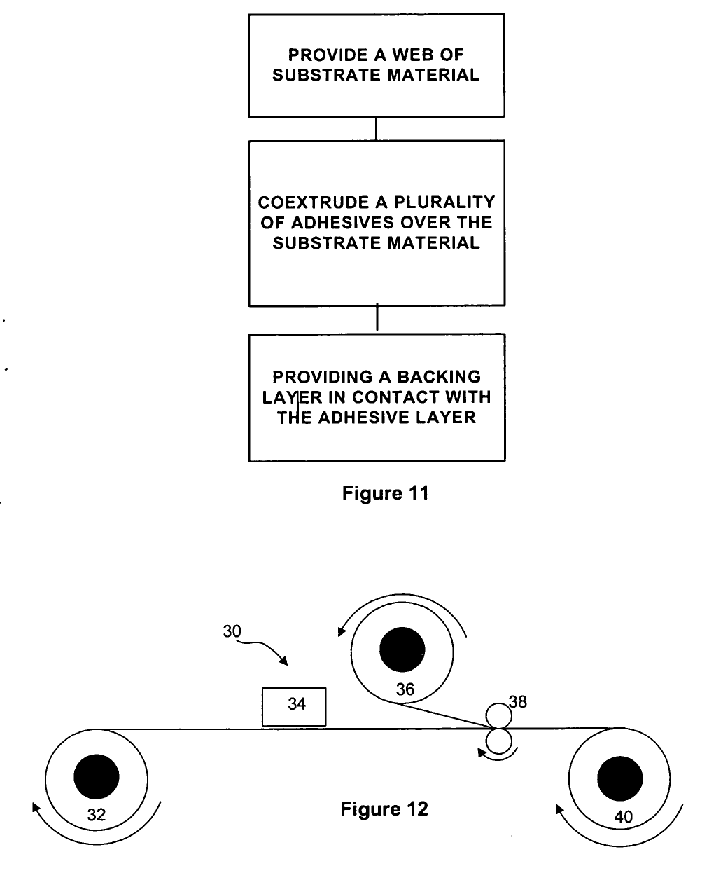

FIG. 11 illustrates one method of forming the flashing material 10. Referring to FIG. 11, Step 20 calls for providing a web of substrate material, wherein the substrate material has a first surface that is substantially impervious to moisture. Step 22 calls for coextruding a plurality of adhesives over the second surface of the substrate material. Step 24 is optional and provides for providing a backing layer (or release liner) in contact with the adhesive layer. The backing layer generally simplifies production by allowing the web of flashing material to be rolled up for shipment or further processing depending on the particular application.

Referring to FIG. 12, a system 30 in accordance with the method of FIG. 11 is illustrated. This method is generally conducted on high-speed production machinery on the order of about 100-500 foot per minute. More specifically, a web of substrate material 32 is provided. Applicator station 34 coextrudes a plurality of adhesives at a temperature above the liquid state of the adhesives, over the substrate web, as the web passes the applicator station 34. A web of backing layer (or release liner) 36 is provided to the adhesive layer just prior to entry into a nip roller 38. The nip roller 38 laminates the backing layer 36 to the flashing material (substrate layer and adhesive layer). The combined laminate, including the flashing material and the backing layer 36, may then be rolled up or otherwise converted at take-up station 40.

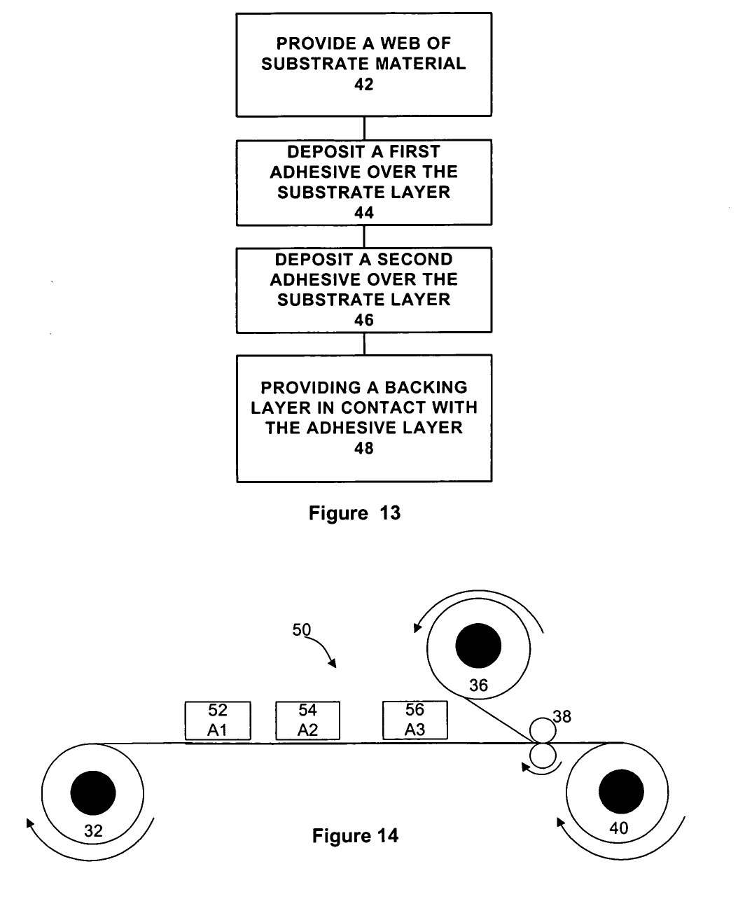

FIG. 13 illustrates another method of forming the flashing material 10. Referring to FIG. 13, Step 42 calls for providing a web of substrate material, wherein the substrate material has a first surface that is substantially impervious to moisture. Step 44 calls for depositing a first adhesive over the substrate layer. Step 46 calls for depositing a second adhesive over the substrate layer. Step 48 is optional and provides for providing a backing layer (or release liner) in contact with the adhesive layer. As stated above, the backing layer generally simplifies production by allowing the web of flashing material to be rolled up for shipment or further processing depending on the particular application. In one embodiment, the substrate material can be coated with substrate release coating on its top surface so that the entire construction can be wound upon itself.

Referring to FIG. 14, a system 50 in accordance with the method of FIG. 13 is illustrated. This method is generally conducted on high-speed production machinery on the order of about 100-500 foot per minute. More specifically, a web of substrate material 32 is provided. One adhesive is sequentially applied at applicator stations 52, 54, and optionally 56. In this embodiment, there is generally one applicator station corresponding to the number of adhesives to be sequentially applied. A web of backing layer (or release liner) 36 is provided to the adhesive layer just prior to entry into a nip roller 38. The nip roller 38 laminates the backing layer 36 to the flashing material (substrate layer and adhesive layer). The combined laminate, including the flashing material and the backing layer 36, may then be rolled up or otherwise converted at take-up station 40.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A flashing material comprising:
a substrate layer having a first surface and a second surface, wherein the first surface is substantially impervious to moisture; and
an adhesive surface nominally parallel to the first surface and comprising a plurality of adhesives.

2. The flashing material of claim 1, wherein the substrate layer comprises a polymeric film or laminate.

3. The flashing material of claim 2 wherein polymeric film or laminate further comprises a polyolefin.

4. The flashing material of claim 1, wherein the plurality of adhesives are sequentially applied simultaneously to form the adhesive layer.

5. The flashing material of claim 3, wherein the plurality of adhesives are coextruded to form the adhesive layer.

6. A flashing material of claim 1, wherein the adhesive layer comprises at least one adhesive having at least one components comprising at least one of the group: chloroprene rubber, natural rubber, styrene butadiene rubber, butyl rubber, nitrile rubber, acrylic polymers or copolymers, polyisobutylene, asphalt, styrenic block copolymers, ethylene propylene copolymer or ethylene propylene terpolymers.

7. The flashing material of claim 1, wherein the plurality of adhesives are sequentially applied one after another to form the adhesive layer.

8. The flashing material of claim 1, wherein the plurality of adhesives are applied to form a pattern on the adhesive layer.

9. The flashing material of claim 7, wherein the pattern applied is a plurality of stripes.

10. The flashing material of claim 7, wherein the pattern applied is a plurality of blocks.

11. The flashing material of claim 7, wherein the pattern applied is a plurality of diamonds.

12. The flashing material of claim 7, wherein the pattern applied is a plurality of triangles.

13. The flashing material of claim 1, wherein the plurality of adhesives are selected based upon an associated building material upon which the adhesive layer is to be applied.

14. The flashing material of claim 1 further including a release liner removably secured to the adhesive layer.

15. A method of making a flashing material, the method comprising:
providing a substrate layer having a first surface and a second surface, wherein the first surface is substantially impervious to moisture; and
depositing an adhesive layer including a plurality of adhesives over the second surface of the substrate layer.

16. The method of claim 14 further including removably securing a release liner to the adhesive layer.

17. The method of claim 14 further including forming a pattern with the plurality of adhesives to form the adhesive layer.

18. The flashing material of claim 16, wherein the plurality of adhesives are sequentially applied simultaneously to form the adhesive layer.

19. The method of claim 17, wherein the plurality of adhesives are coextruded to form the adhesive layer.

20. The method of claim 18, wherein the plurality of adhesives form a pattern in the adhesive layer.

21. The method of claim 14, wherein the plurality of adhesives are sequentially applied one after the other to form the adhesive layer.

22. The method of claim 18, wherein the plurality of adhesives form a pattern in the adhesive layer.
